(19) United States
(12) Patent Application Publication
(10) Pub. No.: US 2004/0029607 A1
(43) Pub. Date: Feb. 12, 2004

(54) Method and system for providing consumer products in the embedded system market

(76) Inventors: Paul L. Master, Sunnyvale, CA (US); John Watson, Edgewood, WA (US)

Correspondence Address: SAWYER LAW GROUP LLP, P O BOX 51418, PALO ALTO, CA, 94303, US

(21) Appl. No.: 10/010,018

(22) Filed: Dec. 5, 2001

(51) Int. Cl. H04M 1/00

(52) U.S. Cl. 455/550.1

(57) ABSTRACT

Aspects of providing consumer products in the embedded systems market are described. These aspects include utilizing adaptive silicon as a hardware foundation of an electronic product. Further, procurement of a digitation file is required to establish a hardware designation and software application for the adaptive silicon. The electronic product then is operated according to the digitation file.

### FIELD OF THE INVENTION

The present invention relates to providing consumer products in the embedded systems market.

### BACKGROUND OF THE INVENTION

The electronics industry has become increasingly driven to meet the demands of high-volume consumer applications, which comprise a majority of the embedded systems market. Embedded systems face challenges in producing performance with minimal delay, minimal power consumption, and at minimal cost. As the numbers and types of consumer applications where embedded systems are employed increases, these challenges become even more pressing. Examples of consumer applications where embedded systems are employed include handheld devices, such as cell phones, personal digital assistants (PDAs), global positioning system (GPS) receivers, digital cameras, etc. By their nature, these devices are required to be small, low-power, light-weight, and feature-rich.

As consumer products, these devices also must remain cost competitive. Typically, the cost for consumer products in the embedded systems market is driven by the cost of the silicon hardware. A need remains for an improved approach in the embedded systems market that reduces the costs associated with the silicon hardware while maintaining an ability to achieve sophisticated operations within without sacrificing financial gain from the sale of the consumer product. The present invention addresses such a need.

### SUMMARY OF THE INVENTION

Aspects of providing consumer products in the embedded systems market are described. These aspects include utilizing adaptive silicon as a hardware foundation of an electronic product. Further, procurement of a digitation file is required to establish a hardware designation and software application for the adaptive silicon. The electronic product then is operated according to the digitation file.

In this manner, the hardware and software are substantially one. However, the value of the adaptive silicon is relative to the digitation file, since it is actually the digitation file that determines the configuration that the hardware takes to perform desired operations. These and other advantages will become readily apparent from the following detailed description and accompanying drawings.

### BRIEF DESCRIPTION OF THE DRAWINGS

FIG. 1a is a block diagram illustrating a preferred embodiment of providing a consumer product in accordance with the present invention.

FIG. 1b is a simple flowchart illustrating providing the consumer product in accordance with the present invention.

FIG. 2 is a block diagram illustrating an adaptive computing engine.

FIG. 3 is a block diagram illustrating, in greater detail, a reconfigurable matrix of the adaptive computing engine.

FIG. 4 illustrates a diagram of a digitation file in accordance with the present invention.

### DETAILED DESCRIPTION OF THE INVENTION

The present invention relates to providing consumer products in the embedded systems market. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention provides an approach to offering an electronic product as two separate consumer items, an adaptive silicon foundation and a digitation file. The adaptive silicon foundation allows for a blank slate onto which a desired hardware designation and software application are applied via the digitation file. Thus, the distinction between software and hardware becomes negligible, as the adaptive silicon remains seemingly useless until the application of the digitation file to the adaptive silicon commences.

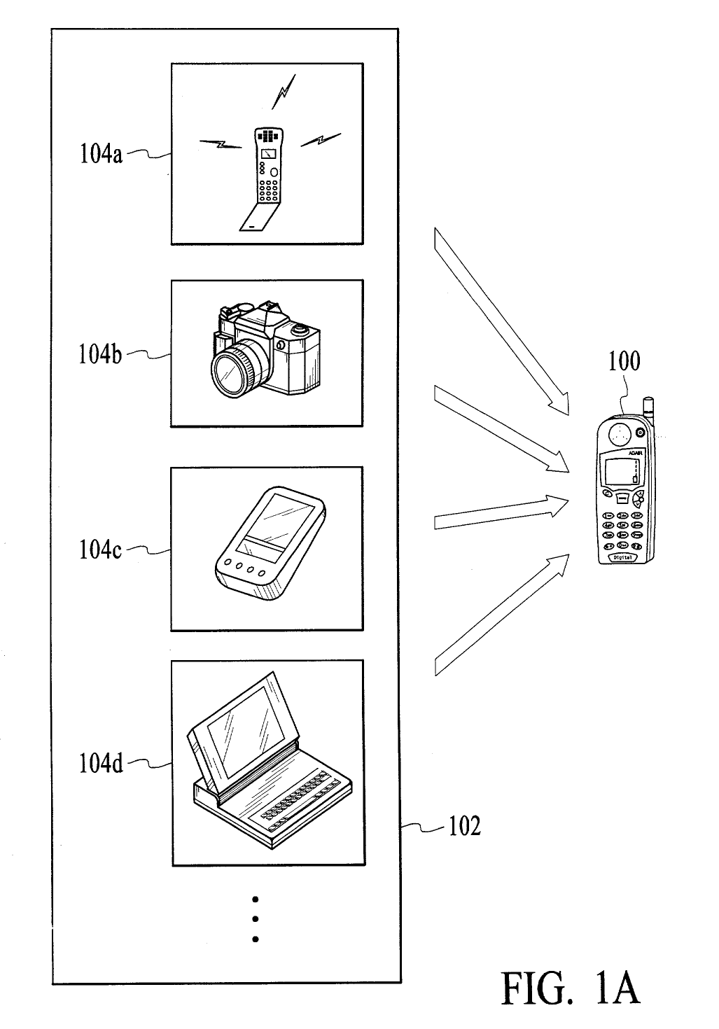

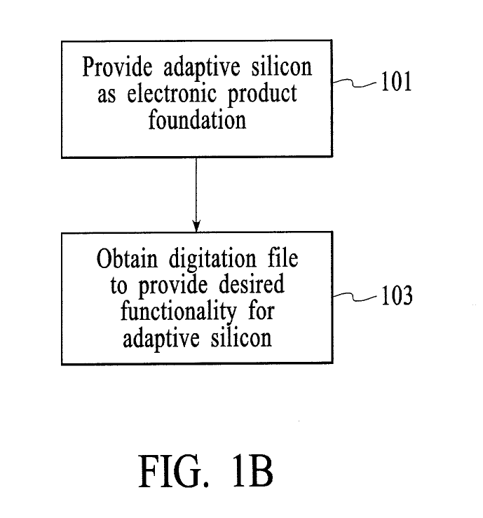

FIG. 1a is a block diagram illustrating a preferred embodiment of providing a consumer product in accordance with the present invention. FIG. 1b is a simple flowchart illustrating providing the consumer product in accordance with the present invention. Referring concurrently to FIGS. 1a and 1b, in a preferred embodiment, the adaptive silicon is presented as a consumer product 100 in the form of a handheld device (step 101). In order to provide the desired functionality into the product 100, a desired digitation file is obtained (step 103). As represented by FIG. 1a, in an exemplary embodiment, the desired digitation file may include one of a plurality of digitation files, each of which is accessible from a computer readable medium 102, such as files on a computer server, e.g., a digititation file 104a to configure the product as a cellular phone; a digitation file 104b to configure the product as a PDA (personal digital assistant); a digitation file 104c to configure the product as a calculator; and a digitation file 104d to configure the product as a digital camera. Of course, the types of consumer products and digitation files described are meant to be illustrative and not restrictive of the types, so that further future developments for handheld electronic devices are also expected to be able to be applicable to the aspects of the present invention. Further, the procurement of the desired digitation file occurs by any suitable method that allows a consumer to download or otherwise apply the digitation file onto the adaptive silicon. Additionally, the download may include updates to a particular configuration rather than a change to a new configuration.

By the nature of the digitation file providing the hardware designation and software application for the adaptive silicon, the value of the actual silicon performing the operations of the product is relative to the value of the digitation file. This represents a shift from the typical paradigm of consumer products, where the silicon hardware often is designed to perform the particular function of the device, as in an ASIC approach, and thus, the silicon hardware bears the value and the costs associated with the device. In contrast, with the present invention, the cost of the silicon becomes of much less significance, while the digitation file bears more of the value and the costs associated with the device.

In a preferred embodiment, the adaptive silicon is provided as an adaptive computing engine (ACE). A more detailed discussion of the aspects of an ACE are provided in copending U.S. patent application Ser. No. 09/815,122 entitled “Adaptive Integrated Circuitry with Heterogeneous and Reconfigurable Matrices of Diverse and Adaptive Computational Units Having Fixed, Application Specific Computational Elements,” filed Mar. 22, 2001, and assigned to the assignee of the present invention. Portions of that discussion are presented in the following in order to more full illustrate the aspects of the present invention.

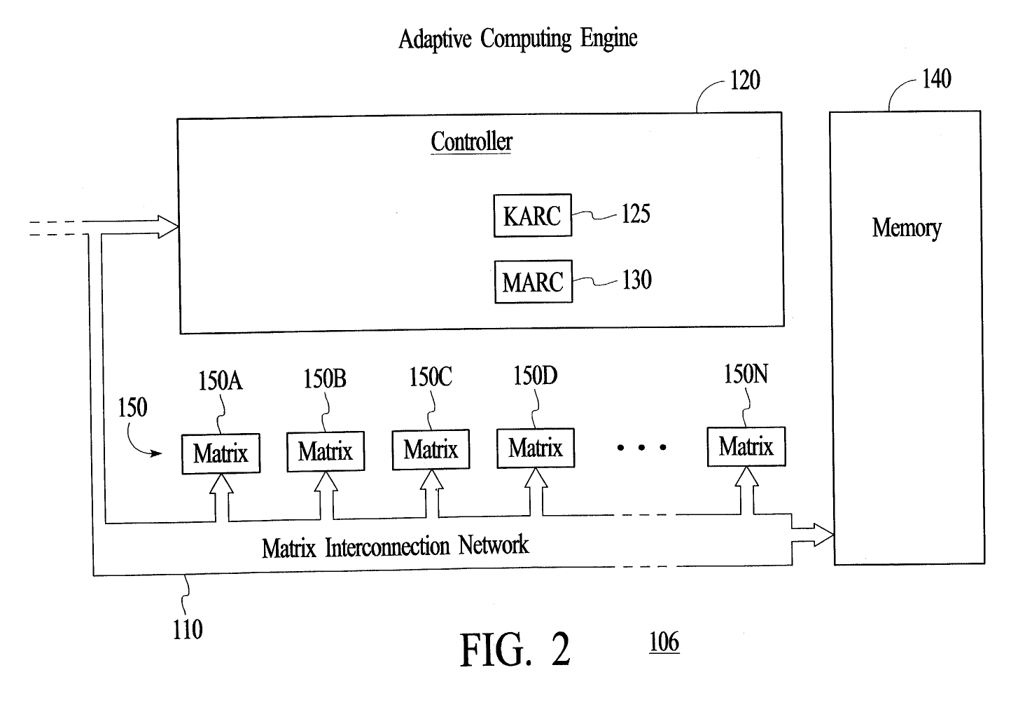

FIG. 2 is a block diagram illustrating an adaptive computing engine (“ACE”) 106 that includes a controller 120, one or more reconfigurable matrices 150, such as matrices 150A through 150N as illustrated, a matrix interconnection network 110, and preferably also includes a memory 140.

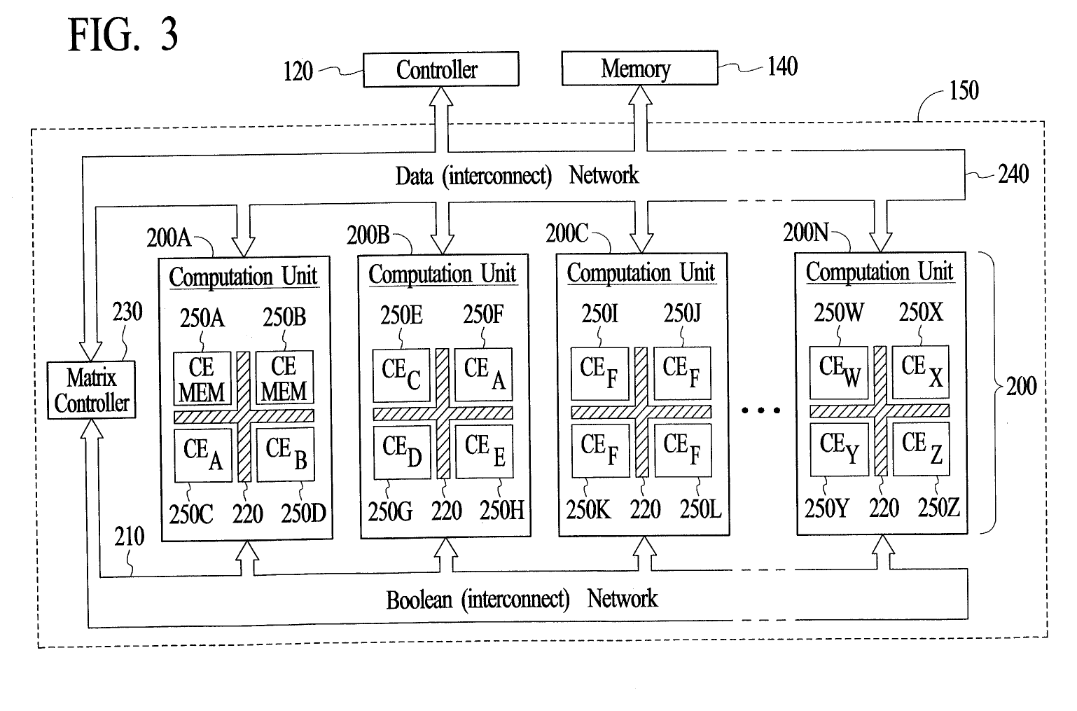

FIG. 3 is a block diagram illustrating, in greater detail, a reconfigurable matrix 150 with a plurality of computation units 200 (illustrated as computation units 200A through 200N), and a plurality of computational elements 250 (illustrated as computational elements 250A through 250Z), and provides additional illustration of the preferred types of computational elements 250 and a useful summary of aspects of the present invention. As illustrated in FIG. 3, any matrix 150 generally includes a matrix controller 230, a plurality of computation (or computational) units 200, and as logical or conceptual subsets or portions of the matrix interconnect network 110, a data interconnect network 240 and a Boolean interconnect network 210. The Boolean interconnect network 210, as mentioned above, provides the reconfigurable interconnection capability between and among the various computation units 200, while the data interconnect network 240 provides the reconfigurable interconnection capability for data input and output between and among the various computation units 200. It should be noted, however, that while conceptually divided into reconfiguration and data capabilities, any given physical portion of the matrix interconnection network 110, at any given time, may be operating as either the Boolean interconnect network 210, the data interconnect network 240, the lowest level interconnect 220 (between and among the various computational elements 250), or other input, output, or connection functionality.

Continuing to refer to FIG. 3, included within a computation unit 200 are a plurality of computational elements 250, illustrated as computational elements 250A through 250Z (collectively referred to as computational elements 250), and additional interconnect 220. The interconnect 220 provides the reconfigurable interconnection capability and input/output paths between and among the various computational elements 250. As indicated above, each of the various computational elements 250 consist of dedicated, application specific hardware designed to perform a given task or range of tasks, resulting in a plurality of different, fixed computational elements 250. Utilizing the interconnect 220, the fixed computational elements 250 may be reconfigurably connected together to execute an algorithm or other function, at any given time.

In a preferred embodiment, the various computational elements 250 are designed and grouped together, into the various reconfigurable computation units 200. In addition to computational elements 250 which are designed to execute a particular algorithm or function, such as multiplication, other types of computational elements 250 are also utilized in the preferred embodiment. As illustrated in FIG. 3, computational elements 250A and 250B implement memory, to provide local memory elements for any given calculation or processing function (compared to the more “remote” memory 140). In addition, computational elements 250I, 250J, 250K and 250L are configured (using, for example, a plurality of flip-flops) to implement finite state machines, to provide local processing capability, especially suitable for complicated control processing.

With the various types of different computational elements 250, which may be available, depending upon the desired functionality of the ACE 106, the computation units 200 may be loosely categorized. A first category of computation units 200 includes computational elements 250 performing linear operations, such as multiplication, addition, finite impulse response filtering, and so on. A second category of computation units 200 includes computational elements 250 performing non-linear operations, such as discrete cosine transformation, trigonometric calculations, and complex multiplications. A third type of computation unit 200 implements a finite state machine, such as computation unit 200C as illustrated in FIG. 3, particularly useful for complicated control sequences, dynamic scheduling, and input/output management, while a fourth type may implement memory and memory management, such as computation unit 200A as illustrated in FIG. 3. Lastly, a fifth type of computation unit 200 may be included to perform digitation-level manipulation, such as for encryption, decryption, channel coding, Viterbi decoding, and packet and protocol processing (such as Internet Protocol processing).

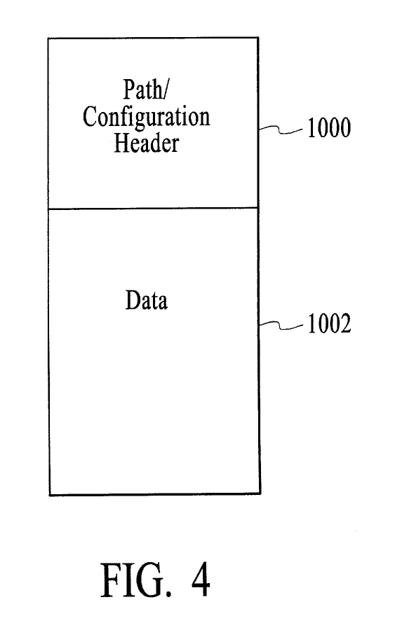

Next, a digitation file represents a tight coupling (or interdigitation) of data and configuration (or other control) information, within one, effectively continuous stream of information. As illustrated in the diagram of FIG. 4, the continuous stream of data ca be characterized as including a first portion 1000 that provides adaptive instructions and configuration data and a second portion 1002 that provides data to be processed. This coupling or commingling of data and configuration information is referred to as a “silverware” module and helps to enable real-time reconfigurability of the ACE 106. For example, as an analogy, a particular configuration of computational elements, as the hardware to execute a corresponding algorithm, may be viewed or conceptualized as a hardware analog of “calling” a subroutine in software that may perform the same algorithm. As a consequence, once the configuration of the computational elements has occurred, as directed by the configuration information, the data for use in the algorithm is immediately available as part of the silverware module. The immediacy of the data, for use in the configured computational elements, provides a one or two clock cycle hardware analog to the multiple and separate software steps of determining a memory address and fetching stored data from the addressed registers. This has the further result of additional efficiency, as the configured computational elements may execute, in comparatively few clock cycles, an algorithm which may require orders of magnitude more clock cycles for execution if called as a subroutine in a conventional microprocessor or DSP.

This use of silverware modules, as a commingling of data and configuration information, in conjunction with the real-time reconfigurability of heterogeneous and fixed computational elements 250 to form different and heterogeneous computation units 200 and matrices 150, enables the ACE 100 architecture to have multiple and different modes of operation. For example, when included within a hand-held device, given a corresponding silverware module, the ACE 100 may have various and different operating modes as a cellular or other mobile telephone, a music player, a pager, a personal digital assistant, and other new or existing functionalities. In addition, these operating modes may change based upon the physical location of the device; for example, when configured as a CDMA mobile telephone for use in the United States, the ACE 100 may be reconfigured as a GSM mobile telephone for use in Europe.

From the foregoing, it will be observed that numerous variations and modifications may be effected without departing from the spirit and scope of the novel concept of the invention. For example, although the present invention has been described in a preferred embodiment in the context of handheld electronic devices, particularly cellular phones, the present invention is considered applicable to other devices/environments that utilize a combination of adaptive silicon and a digitation file. It is to be understood that no limitation with respect to the specific methods and apparatus illustrated herein is intended or should be inferred. It is, of course, intended to cover by the appended claims all such modifications as fall within the scope of the claims.

What is claimed is:

1. A method for providing consumer products in the embedded systems market, the method comprising:
utilizing adaptive silicon as a hardware foundation of an electronic product; and
requiring procurement of a digitation file to establish a hardware designation and software application for the adaptive silicon to provide the electronic product.

2. The method of claim 1 further comprising utilizing the adaptive silicon as established by the digitation file to perform operations in the electronic product.

3. The method of claim 1 wherein the electronic product further comprises a consumer handheld device.

4. The method of claim 1 further comprising operating the electronic product as a cellular phone.

5. The method of claim 1 further comprising downloading a new digitation file to provide an alternate hardware designation and software application for the adaptive silicon to provide a different electronic product.

6. The method of claim 1 wherein utilizing adaptive silicon further comprises utilizing an adaptive computing engine.

7. The method of claim 6 wherein utilizing an adaptive computing engine further comprises utilizing a controller, one or more reconfigurable matrices, a matrix interconnection network, and a memory.

8. A method for providing consumer products in the embedded systems market, the method comprising:
forming an electronic product as an adaptive silicon portion structured for operation by a digitation file; and
offering the electronic product as two separate consumer items, the adaptive silicon portion and the digitation file, wherein the digitation file bears a higher percentage of a total cost of the electronic product.

9. The method of claim 8 further comprising offering a selection of multiple, separate digitation files to provide alternative structures for the silicon portion.

10. The method of claim 8 wherein forming further comprises forming a cellular phone.

11. The method of claim 8 further comprising selecting one of the digitation files and downloading the selected digitation file into the electronic product.

12. The method of claim 8 wherein the adaptive silicon portion further comprises an adaptive computing engine.

13. The method of claim 12 wherein the adaptive computing engine further comprises a controller, one or more reconfigurable matrices, a matrix interconnection network, and a memory.
